(19) United States
(12) Patent Application Publication
(10) Pub. No.: US 2005/0213142 A1
(43) Pub. Date: Sep. 29, 2005

(54) Optimization techniques during processing of print jobs

(76) Inventors: Raymond Edward Clark, Georgetown, KY (US); Robert Laurence Cook, Lexington, KY (US); Ning Ren, Lexington, KY (US); Martin Geoffrey Rivers, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/810,143

(22) Filed: Mar. 26, 2004

(51) Int. Cl. G06F 15/00

(52) U.S. Cl. 358/1.15

(57) ABSTRACT

Methods for processing print jobs in rendering devices include constructing display list objects for to-be-printed objects and comparing attributes thereof for sameness and compatibility. If same or compatible, attributes become shared and memory locations with redundant information are freed for use with other processing operations. In one aspect, the invention allows sharing of attributes for adjacent objects, for any two objects or for all objects. Pointers of the objects having shared attributes may become modified to point to a new location or eliminated altogether. The object itself may also become eliminated. Preferably, attribute comparison includes comparing color values of ink attributes for exactness and comparing vector drawing commands of region attributes for comparability. Individual objects on the display list can be linked together and a root may precede the first object. Computer readable media and graphics engines in laser printers are preferred structures for comparing attributes.

### FIELD OF THE INVENTION

The present invention relates to achieving optimization during processing of print jobs in a rendering device, such as a printer. In one aspect, it relates to constructing display list objects, corresponding to the to-be-printed objects of the print job, and comparing the attributes thereof. In another, it relates to sharing attributes, in memory, if possible. Once shared, no-longer-needed memory locations can be freed and pointers can be modified to point elsewhere or eliminated. Objects of the display list may also be eliminated.

### BACKGROUND OF THE INVENTION

The art of printing with rendering devices, such as laser or other printers, is relatively well known. In general, printing results by creating a bitmap of the print job and sending the bitmap to appropriate printing mechanisms to obtain a hard copy output. During processing, some rendering devices create display lists to intermediately represent the to-be-printed objects. Appreciating that thousands of memory locations or more are required for this intermediate representation, rendering devices can mismanage their available memory which sometimes leads to print overruns. Moreover, memory mismanagement can slow the print job processing time. Accordingly, a need exists in the printing arts for achieving optimization in memory usage and processing time.

### SUMMARY OF THE INVENTION

The above-mentioned and other problems become solved by applying the principles and teachings associated with the hereinafter described methods and apparatus for achieving optimization during processing of print jobs in rendering devices, such as printers.

Methods for achieving optimization include constructing display list objects for to-be-printed objects of a print job and comparing attributes thereof for sameness and compatibility. If the attributes are the same, they become shared and memory locations with redundant information are freed for use in other processing operations. They can also become shared by appending one or more together in related memory locations. Pointers of the objects can become modified to point from an original memory location(s) to the shared memory location(s) or can become eliminated altogether. The entire object may also be eliminated from the display list. Preferred attribute comparison includes comparing color values of ink attributes of objects for exactness or sameness and comparing vector drawing commands of region attributes for comparability or compatibility. Individual objects can be linked together on the display list in a variety of ways and a root preferably precedes the objects. After optimization, to-be-printed objects are rendered into device specific pages in memory. Rendering includes conversion of color values from a first color space into a second color space of the rendering device and applying halftoning. Rendering can occur on a page-by-page basis of the print job or after all pages of the print job are received. The device specific pages include bitmaps ready for hand-off to an engine interface to invoke the print mechanisms of the printer.

Printer drivers for installation on host devices and graphics engines in laser printers are preferred structures for practicing the foregoing. To store information, both have dedicated memory or access to non-dedicated memory. The graphics engine embodiment preferably includes an interface with one or more PDL emulators dedicated to processing a particular language type, such as PCL, Postcript or the like. It also includes an interface with an engine interface and, when processing is complete, the graphics engine hands off a bitmap, in device specific colors and halftoned, to an engine interface to invoke the print mechanisms of a laser printer to produce a hard copy output. The printer driver embodiment preferably includes computer executable instructions on optical disks or other storage medium and/or can be downloaded from the internet, for example.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1 is a diagrammatic view in accordance with the teachings of the present invention of a representative operating environment in which the invention may be practiced;

FIG. 2 is a diagrammatic view in accordance with the teachings of the present invention of a rendering device in the form of a laser printer;

FIGS. 3A-3F are representative memory pages in accordance with the teachings of the present invention for producing a hard copy output;

FIG. 4 is a flow chart in accordance with the teachings of the present invention indicating when the graphics engine preferably renders to-be-printed objects for a given to-be-printed page of a print job into device specific pages in memory;

FIG. 5 is a diagrammatic view in accordance with the teachings of the present invention of a display list object;

FIG. 6A is a diagrammatic view in accordance with the teachings of the present invention of a display list having pluralities of objects;

FIG. 6B is a diagrammatic view in accordance with the teachings of the present invention of an alternate embodiment of a display list having pluralities of objects;

FIG. 7 is a diagrammatic view in accordance with the teachings of the present invention of a display list having pluralities of objects and a root;

FIG. 8 is a diagrammatic view in accordance with the teachings of the present invention of pluralities of objects on a display list having the same color values for two of the ink attributes;

FIG. 9 is a diagrammatic view in accordance with the teachings of the present invention of the pluralities of objects on a display list of FIG. 8 having a pointer modified to point at shared memory locations and freed memory for one of the objects;

FIG. 10 is a diagrammatic view in accordance with the teachings of the present invention of an alternate embodiment of the pluralities of objects on a display lists of FIG. 8 having a modified pointer and freed memory for one of the objects;

FIG. 11 is a diagrammatic view in accordance with the teachings of the present invention of pluralities of objects on a display list having the same color values for all of the ink attributes;

FIG. 12 is a diagrammatic view in accordance with the teachings of the present invention of the pluralities of objects on a display list of FIG. 11 having modified pointers and freed memory for two of the objects;

FIG. 13 is a flow chart in accordance with the teachings of the present invention for comparing attributes of objects on a display list and optimizing same if possible;

FIG. 14 is a diagrammatic view in accordance with the teachings of the present invention of pluralities of objects on a display list having vector drawing commands as part of their region attribute;

FIG. 15 is a diagrammatic view in accordance with the teachings of the present invention of the pluralities of objects on a display list of FIG. 14 having combined vector drawing commands in a single region attribute;

FIG. 16 is a diagrammatic view in accordance with the teachings of the present invention of an alternate embodiment of the pluralities of objects on a display list of FIG. 14 having combined vector drawing commands in a single region attribute;

FIG. 17 is a diagrammatic view in accordance with the teachings of the present invention of another alternate embodiment of the pluralities of objects on a display list of FIG. 14 having combined vector drawing commands in a single region attribute; and

FIG. 18 is a flow chart in accordance with the teachings of the present invention of an alternate embodiment for comparing attributes of objects on a display list and optimizing same if possible.

### DETAILED DESCRIPTION OF THE PREFERRED EMBODIMENTS

In the following detailed description of the preferred embodiments, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that process, electrical, mechanical and/or software changes may be made without departing from the scope of the present invention. The following detailed description is, therefore, not to be taken in a limiting sense, and the scope of the present invention is defined only by the appended claims and their equivalents. In accordance with the present invention, methods and apparatus for achieving optimization during processing print jobs in a rendering device are hereinafter described.

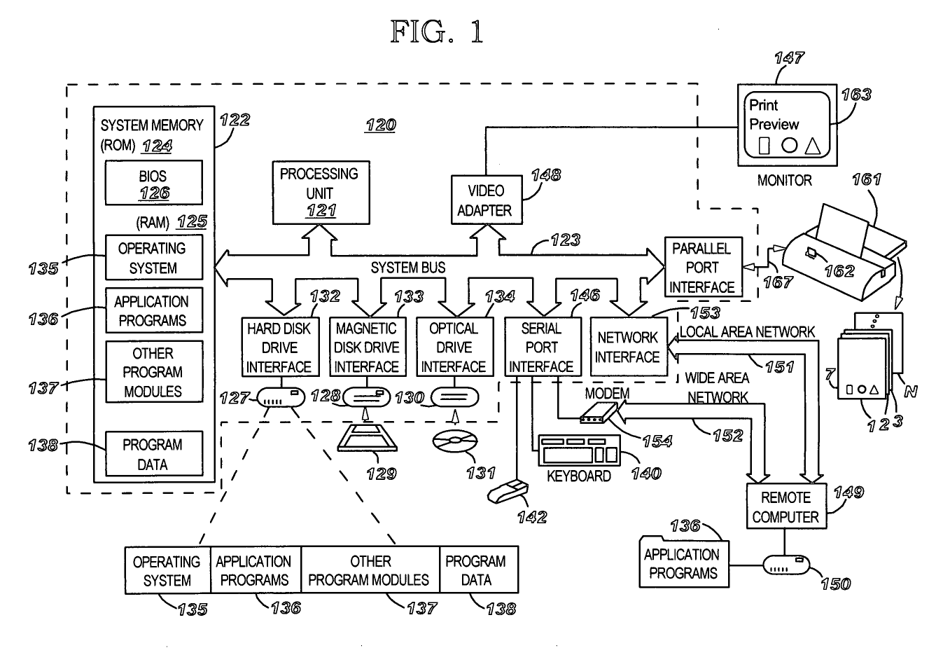

Appreciating users of the invention will likely accomplish some aspect of the methods in a computing system environment, FIG. 1 and the following discussion are intended to provide a brief, general description of a suitable computing environment in which either the structure or processing of embodiments may be implemented. Since the following may be computer implemented, particular embodiments may range from computer executable instructions as part of computer readable media to hardware used in any or all of the following depicted structures. Implementation may additionally be combinations of hardware and computer executable instructions. Further, implementation may occur in an environment not having the following computing system environment so the invention is only limited by the appended claims and their equivalents.

When described in the context of computer readable media having computer executable instructions stored thereon, it is denoted that the instructions include program modules, routines, programs, objects, components, data structures, patterns, trigger mechanisms, signal initiators, etc. that perform particular tasks or implement particular abstract data types upon or within various structures of the computing environment. Executable instructions exemplarily comprise instructions and data which cause a general purpose computer, special purpose computer, or special or general purpose processing device to perform a certain function or group of functions.

The computer readable media can be any available media which can be accessed by a general purpose or special purpose computer or device. By way of example, and not limitation, such computer readable media can comprise RAM, ROM, EEPROM, CD-ROM or other optical disk storage devices, magnetic disk storage devices or any other medium which can be used to store the desired executable instructions or data fields and which can then be accessed. Combinations of the above should also be included within the scope of the computer readable media. For brevity, computer readable media having computer executable instructions may sometimes be referred to as software or computer software.

With reference to FIG. 1, an exemplary system for implementing the invention includes a general purpose computing device in the form of a conventional computer 120. The computer 120 includes a processing unit 121, a system memory 122, and a system bus 123 that couples various system components including the system memory to the processing unit 121. The system bus 123 may be any of the several types of bus structures including a memory bus or memory controller, a peripheral bus, and a local bus using any of a variety of bus architectures. The system memory includes read only memory (ROM) 124 and a random access memory (RAM) 125. A basic input/output system (BIOS) 126, containing the basic routines that help to transfer information between elements within the computer 120, such as during start-up, may be stored in ROM 124. The computer 120 may also include a magnetic hard disk drive 127, a magnetic disk drive 128 for reading from and writing to removable magnetic disk 129, and an optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide nonvolatile storage of computer readable instructions, data structures, program modules and other data for the computer 120.

Although the exemplary environment described herein employs a hard disk 127, a removable magnetic disk 129 and a removable optical disk 131, it should be appreciated by those skilled in the art that other types of computer readable media exist which can store data accessible by a computer, including magnetic cassettes, flash memory cards, digital video disks, removable disks, Bernoulli cartridges, random access memories (RAMs), read only memories (ROM), and the like. Other storage devices are also contemplated as available to the exemplary computing system. Such storage devices may comprise any number or type of storage media including, but not limited to, high-end, high-throughput magnetic disks, one or more normal disks, optical disks, jukeboxes of optical disks, tape silos, and/or collections of tapes or other storage devices that are stored off-line. In general however, the various storage devices may be partitioned into two basic categories. The first category is local storage which contains information that is locally available to the computer system. The second category is remote storage which includes any type of storage device that contains information that is not locally available to a computer system. While the line between the two categories of devices may not be well defined, in general, local storage has a relatively quick access time and is used to store frequently accessed data, while remote storage has a much longer access time and is used to store data that is accessed less frequently. The capacity of remote storage is also typically an order of magnitude larger than the capacity of local storage.

A number of program modules may be stored on the hard disk, magnetic disk 129, optical disk 131, ROM 124 or RAM 125, including but not limited to an operating system 135, one or more application programs 136, other program modules 137, and program data 138. Such application programs may include, but are not limited to, word processing programs, drawing programs, games, viewer modules, graphical user interfaces, image processing modules, intelligent systems modules or other known or hereinafter invented programs. A user enters commands and information into the computer 120 through input devices such as keyboard 140 and pointing device 142. Other input devices (not shown) may include a microphone, joy stick, game pad, satellite dish, scanner, camera, personal data assistant, or the like. These and other input devices are often connected to the processing unit 121 through a serial port interface 146 that couples directly to the system bus 123. It may also connect by other interfaces, such as parallel port, game port, firewire or a universal serial bus (USB).

A monitor 147 or other type of display device connects to the system bus 123 via an interface, such as a video adapter 148. In addition to the monitor, computers often include other peripheral output devices, such as speakers (not shown). Other output or rendering devices include printers, such as a laser printer 161, for producing hard copy outputs of sheets 1, 2, 3 . . . N of paper or other media, such as transparencies. In general, the hard copy output appears as a representation of what a user might view in a print preview screen 163 of an original program application displayed on the monitor. In this instance, the hard copy appears as three side-by-side objects, especially a red (interior-filled) vertically oriented rectangle, a green ring with a white interior and a blue (interior-filled) triangle, and all reside in a non-overlapping fashion near a bottom 7 of sheet 1. In one embodiment, the printer 161 connects to the computer or host device by direct connection to the system bus via a cable 167 attached to parallel port interface 165. In other embodiments, it connects via the serial port interface, USB, Ethernet or other. Often times a driver, for installing necessary software on the computer 120 for the computer and printer to interface properly and to provide a suitable user interface with the printer via the monitor, becomes inserted as the optical disk 131, the magnetic disk 129 or can be downloaded via the internet or retrieved from another entity as a file. Some forms of the present invention contemplate the driver as storing computer executable instructions for executing the methods of the present invention.

During use, the computer 120 may operate in a networked environment using logical connections to one or more other computing configurations, such as a remote computer 149. Remote computer 149 may be a personal computer, a server, a router, a network PC, a peer device or other common network node, and typically includes many or all of the elements described above relative to the computer 120, although only a memory storage device 150 having application programs 136 has been illustrated. The logical connections between the computer 120 and the remote computer 149 include a local area network (LAN) 151 and/or a wide area network (WAN) 152 that are presented here by way of example and not limitation. Such networking environments are commonplace in offices with enterprise-wide computer networks, intranets and the Internet, but may also be adapted for use in a mobile environment at multiple fixed or changing locations.

When used in a LAN networking environment, the computer 120 is connected to the local area network 151 through a network interface or adapter 153. When used in a WAN networking environment, the computer 120 typically includes a modem 154, T1 line, satellite or other means for establishing communications over the wide area network 152, such as the Internet. The modem 154, which may be internal or external, is connected to the system bus 123 via the serial port interface 146. In a networked environment, program modules depicted relative to the computer 120, or portions thereof, may be stored in the local or remote memory storage devices and may be linked to various processing devices for performing certain tasks. It will be appreciated that the network connections shown are exemplary and other means of establishing a communications link between the computers may be used. Moreover, those skilled in the art will appreciate that the invention may be practiced with other computer system configurations, including host devices in the form of hand-held devices, multi-processor systems, micro-processor-based or programmable consumer electronics, network PCs, minicomputers, computer clusters, main frame computers, and the like.

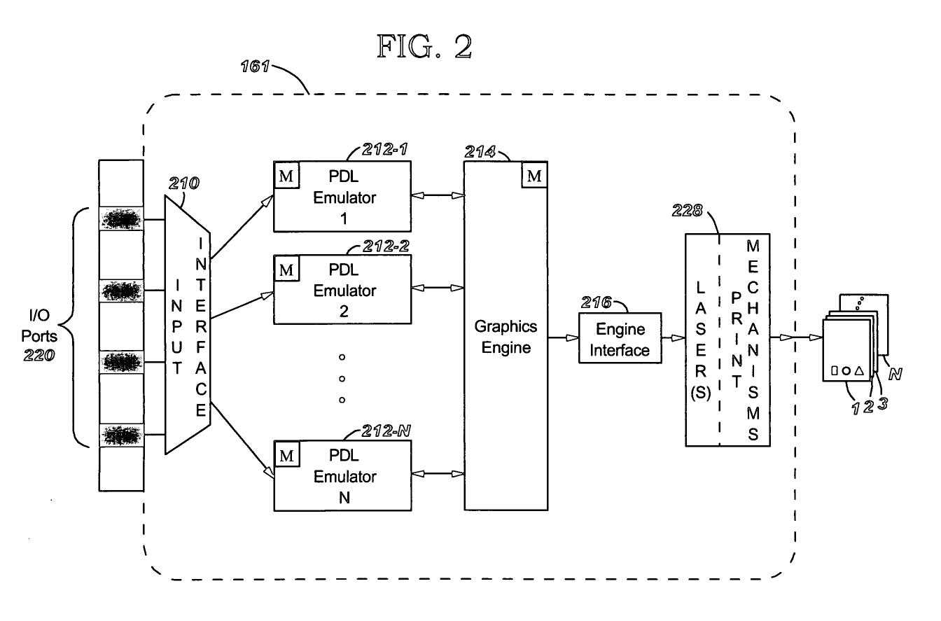

With reference to FIG. 2, the rendering device or printer 161 of FIG. 1 is described in more detail. In one embodiment, the printer includes the following functional blocks: an input interface 210; pluralities of printer description language (PDL) emulators 212-1, 212-2 . . . 212-N; a graphics engine 214; an engine interface 216; and print mechanisms 218, including one or more lasers. Of course, the printer has other well known functional components (not shown) to effectuate printing of sheets 1, 2, 3 . . . N, of a print job including a controller often embodied as an ASIC or microprocessor, system memory, buffers, memory card slots/readers, a user-input control panel with discrete buttons and/or software, and the like. Some of these other components may actually be the source of a print job. The printer connects to the computer 120 (FIG. 1) via IR, wirelessly or a cable connected to one of its many input/output (I/O) ports 220. Representative I/O ports include a parallel port, a serial port, a USB port, or a network port, such as Ethernet, LAN, WAN or the like. In addition to or in substitution for the computer 120, the printer can also interface with other host devices. For example, it may interface directly with a digital camera, a personal data assistant, an optical code reader, a scanner, a memory card, or other known or hereafter developed software or apparatus.

During use, as is known, when the host or other device has a print job ready for printing, the host sends data to the printer in a form ready for processing by the printer. Often, this data embodies the well known form of a PDL. In general, PDL is a language (expression protocol) indicating which parts of a page contain text characters and which parts contain graphic images. It also has instructions on how to draw a to-be-printed object and its control therefor. It further includes a protocol for describing bitmap data. Some of the more well known forms of PDLs include Hewlett Packard's printer control language (PCL), PCLXL, Adobe's POSTSCRIPT, Canon's LIPS, IBM's PAGES and IPDS, to name a few. Yet, the printer may not know how many host or other devices are connected to it, on which I/O port(s) they may reside and in what form the PDL print job will arrive. Accordingly, the input interface 210 of the printer performs the following two well known functions. First, it assesses (by looping through the I/O ports) which, if any, of the I/O ports have a print job for the printer and, if a print job exists, locks onto such port. Second, it supplies the print job to the appropriate PDL emulator 212 in accordance with the PDL language type. As shown in FIG. 2, PDL emulators within the printer preferably exist as one emulator per one PDL language type (e.g., one PDL emulator 212-1 for PCL, one PDL emulator 212-2 for POSTSCRIPT, etc.). Downstream, the PDL emulator communicates/interfaces with the graphics engine 214. Generally speaking, the PDL emulator interfaces between the computer and the graphics engine to interpret the language of the PDL file, of any given print job, for the benefit of the graphics engine.

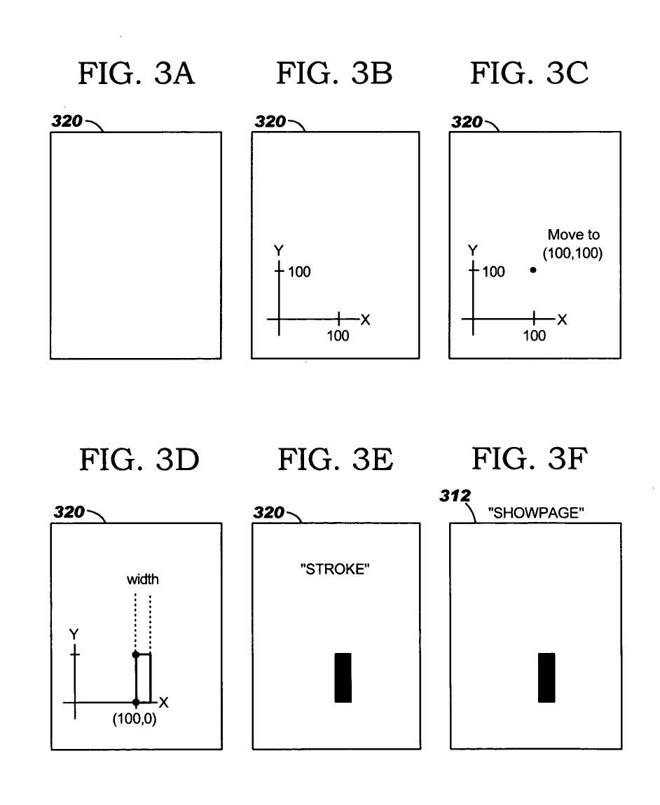

As an example, consider the following PDL file, embodied as an imaginary POSTSCRIPT file, having programming language tokens or command operations, as in Lines 1-6, for rudimentarily printing a thin black line 310 (FIG. 3F) near a bottom center of a to-be-printed page 312 to-be-output from a printer:

| | |
|---|---|
| 0 0 0 setrgbcolor | (Line 1) |
| 1 setlinewidth | (Line 2) |
| 100 100 moveto | (Line 3) |
| 100 0 lineto | (Line 4) |
| stroke | (Line 5) |
| showpage | (Line 6) |

As a preliminary matter, skilled artisans will appreciate the color (black) of the to-be-printed object (e.g., thin black line 310) first appears to the printer in a color space specified by the host or other device and it is incumbent upon the printer to convert such color space into whatever device color space it functions in. In this instance, the color received by the printer corresponds to red, green, blue (r, g, b) color values which, in turn, relate to the colors generated by the monitor 147 (FIG. 1). Many printers function in cyan (C), magenta (M) and yellow (Y) toners, or CMY and black (K), and the printer needs to eventually convert such r, g, b into CMYK.

Interpreting these lines of code, the color (black) of to-be-printed object (i.e., thin black line 310) has a red color in the computer color plane corresponding to a zero value (please appreciate this number can range between a plurality of values which maps to about 256 possible different color selections), a green color corresponding to a zero value and a blue color corresponding to a zero value, or black. The object has a linewidth value of 1 point ( 1/72″, for example). With reference to FIGS. 3A-3E, the to-be-printed object begins in a page of virtual memory 320 at a coordinate value of 100, 100 (e.g., an x-y coordinate plane corresponding to an x-y plane of the to-be-printed page 312). Thereafter, the printer has a line (please appreciate a “line” with a linewidth of 1 point actually appears as a stencil or a rectangular box as seen, greatly exaggerated, in FIG. 3D) drawn in memory from coordinate 100, 100 to the coordinate 100, 0. The operation command “stroke” tells the printer to now “paint” the line (e.g., fill in the stencil or rectangular box). Appreciating all this gets virtually performed in memory before actually printing an object on a piece of paper, the operation command “showpage” actually invokes the lasers, toner and paper pick of the printer to make the thin black line appear on the paper.

Regarding the interaction between the PDL emulator 212 and the graphics engine 214, it occurs in a well known iterative or back-and-forth manner. For example, the PDL emulator sequentially parses or processes a single command line of the above PDL file and relays it to the graphics engine. In response, the graphics engine returns information to the emulator notifying it of completion, for example, and then the PDL emulator goes and processes the next command line. The PDL emulator then communicates to the graphics engine about the next line of the PDL file, whereby the graphics engine responds, and so on until complete. In actuality, however, each individual command line need not require interaction with the graphics engine or any one single command line may invoke many interactions with the graphics engine and is well known in the art. To facilitate processing, each of the emulator and graphics engine have access to their own dedicated memory (M) for these and other purposes. In addition, during the “showpage” command operation, the 0,0,0 red, green, blue colors of the PDL file become converted into the CMYK toner colors of the rendering device printer. Preferably, the graphics engine performs this conversion and stores the printer colors in what artisans refer to as device specific colors or color planes. In this instance, since four colors exist in the printer (C, M, Y, K), the graphics engine stores four color planes. Skilled artisans also know color conversion from computers, or other hosts, into device specific colors occurs through well known processes often comprising specific entries in a look-up table and linear or other interpolation methods between the specific entries.

To actually invoke the lasers of the printer or other print mechanisms 218 (including, but not limited to, paper pick mechanisms, rollers, belts, photoconductive members, fusers, sheet feeders, toner cartridges, duplexers, and the like), the graphics engine 214 communicates directly with an engine interface 216. Preferably, the graphics engine supplies a bitmap rendered in device specific color and halftoned. The engine interface, in turn, supplies the requisite information, usually in the form of signals, to the print mechanisms to produce hard copy sheets 1, 2, 3 . . . N, for example.

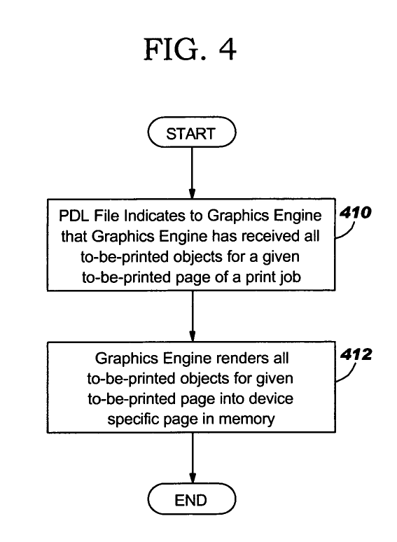

For any given print job, the PDL file (through the PDL emulator) will eventually signal or indicate to the graphics engine that the graphics engine has been presented with or received all to-be-printed objects for a given page of a print job. In some instances, this occurs when the PDL emulator calls for the graphics engine to perform the “showpage” command. With reference to FIG. 4, this step 410 then invokes the graphics engine to render all the to-be-printed objects for that given page into a device specific page in memory, step 412. Preferably, this memory corresponds to the graphics engine dedicated memory M but may be any memory, local or remote, the graphics engine has access to. In an alternate embodiment, the rendering of the to-be-printed objects into device specific pages of memory occurs at the completion of receipt of more than one to-be-printed page of the print job or occurs before the completion of receipt of a single to-be-printed page.

The rendering of to-be-printed objects occurs, first, by having the graphics engine build, create or otherwise construct a display list having one or more to-be-printed objects for a given to-be-printed page. In essence, the display list comprises pluralities of data structures found in addresses or locations linked in memory that together describe a given to-be-printed object(s) and a to-be-printed page. A display list root begins the display list and points to the first object. The first object then points to the second object and so on until all objects are connected, in memory, for a given to-be-printed page of a print job. Preferably, all object(s) on the display list occur in the same exact order that the PDL file presented them to the graphics engine.

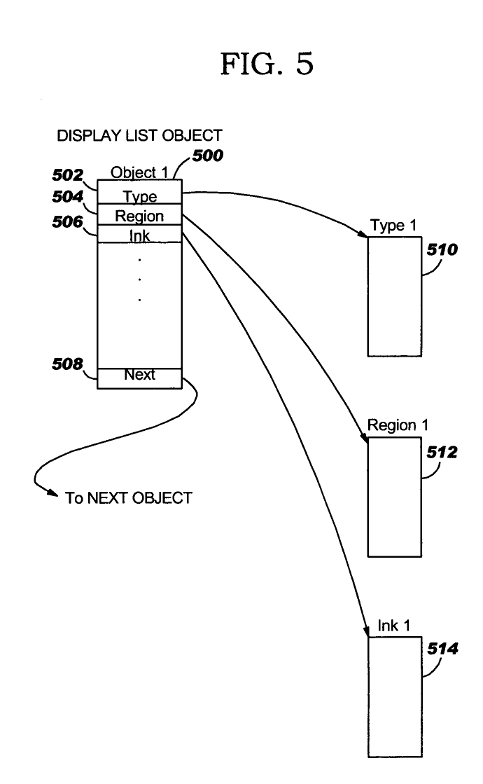

In more specificity, FIG. 5, a display list object 500 for any given object preferably includes, but is not limited to, the attributes of object type 502, object region 504 and object ink 506. Attributes, as used herein, are typically presented to the graphics engine in accordance with the language type of the PDL. Attributes, however, may also be indirectly influenced by the printer or operator, via the driver or operator panel 162 on the printer 161, for example. A next pointer 508 is also included on the display list object 500 but does not substantively represent an attribute of the object. It merely points to the next object on the display list as will be described later in more detail. The attributes themselves point to specific other memory locations or addresses 510, 512, 514 that more particularly define the object type, the object region and the object ink, respectively.

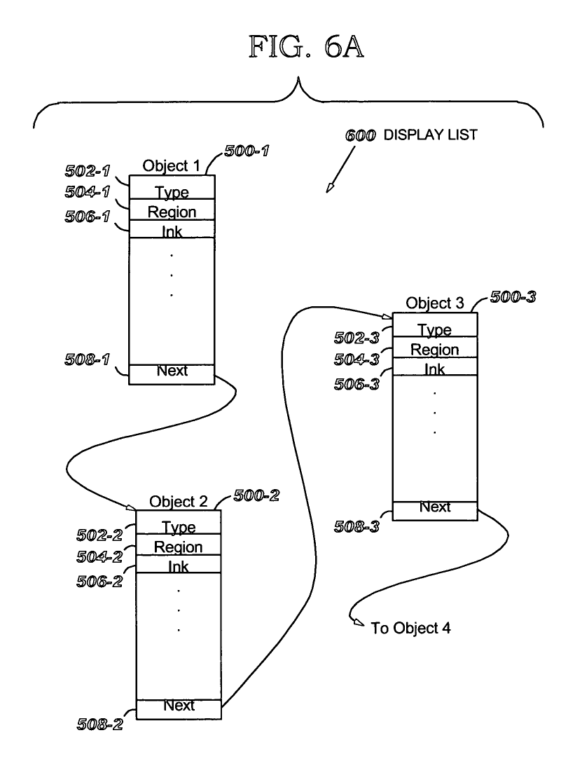

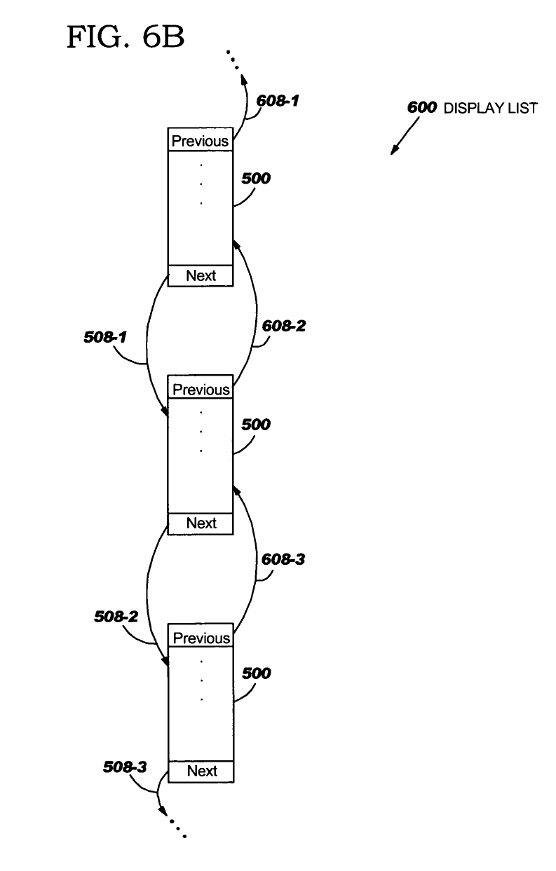

In one embodiment, the object type attribute corresponds to whether the to-be-printed object is an image, such as a jpeg, a stencil, such as a rectangle, or a character (a, b, c . . . x, y, z, 0, 1, 2, . . . ). In other embodiments, it could correspond to a group of related objects. The object region attribute corresponds to the physical location of the to-be-printed object on the to-be-printed page and the geography of the object type, such as the pixel dimensions of a rectangular stencil. It may also include information useful in processing the object such as a region bounding box (not shown). The object ink attribute corresponds generally to how to “paint” each pixel within the object region. With more specificity, the painting of each pixel means 1) what color to apply to each pixel for that to-be-printed object; and 2) how to apply pixel coloring in instances when pixels of multiple objects overlap one another on the to-be-printed page. In category 2), this typically includes a math or logic function specified, in a well known manner by the PDL as part of the PDL file, such as a Boolean expression, when the PDL emulator is of PCL language type, or an algebraic expression for PDF languages. As a representative example, a PCL language has 256 possible logic functions. A PDF language has about 16 math or logic functions. Although shown in a given order on the display list object 500, the attributes may occur in any order desirable and the actual memory locations representing the attributes of the object need not be contiguous or sequential. With reference to FIG. 6A, a more comprehensive display list 600 is shown with pluralities of display list objects 500-1, 500-2, 500-3 linked together for a given to-be-printed page of a print job via the functionality of the next pointer 508-1, 508-2, 508-3 as previously discussed. In FIG. 6B, the objects (generically 500) of the display list 600 may alternatively be doubly linked via the functionality of both next and previous pointers 608-1, 608-2, 608-3, etc. In still other embodiments, the pointers need not point to immediately preceding or following objects and/or each object 500 may have pointers in addition to those shown. Of course, each object 500 still includes their other attributes and ellipses between the next and previous pointers indicate this feature.

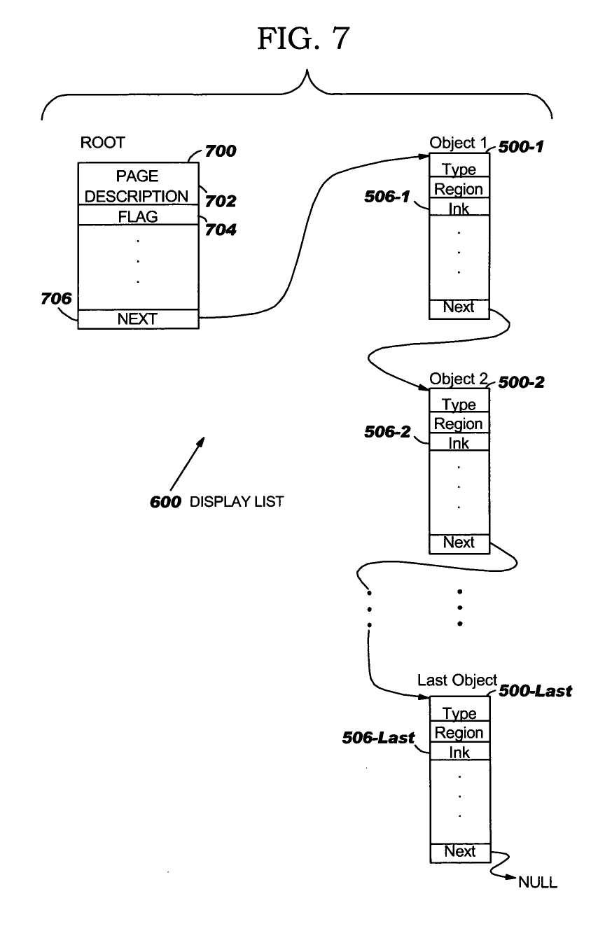

With reference to FIG. 7, the display list 600 for a given to-be-printed page may also include a display list root 700 constructed by the graphics engine, and stored in memory, that precedes the first display list object 500-1 and points thereto. In general, the root describes the physical to-be-printed page and the virtual page in memory corresponding thereto. In one embodiment, the root 700 includes attributes for describing this, including a to-be-printed page description attribute 702 and a flag attribute 704. The page description 702 attribute includes information such as the size of the to-be-printed page (e.g., 8.5″×11″, A4, etc.), page type (e.g., paper, transparency, glossy, etc.) and the like. It may also contain information specifying the color space in which to-be-printed objects will become blended. The flag 704 attribute, as will be described in more detail below, becomes set or not (e.g., on or off) for the entirety of the to-be-printed page to indicate whether any of the math or logic functions within the ink attributes 506-1, 506-2, 506-3, etc., of any of the display list objects 500-1, 500-2, 500-3, etc., include a difficult, complex or otherwise “hard” processing operation. If they do, the flag is set. If they do not, the flag is not set. As used herein, a hard processing operation means any math or logic function, previously described, having two or more inputs. Alternatively, the flag 704 attribute can become set or not for the entirety, or a partiality, of the to-be-printed page to indicate any other criterion or criteria such as the presence or absence, the on or off, or meeting of a condition, or not, in any of the display list objects 500. Still alternatively, the flag attribute may become set or not depending upon whether the math or logic function is a Boolean or an algebraic equation in accordance with the popular PCL or PDF languages. In addition, the condition may reside in an attribute of an object other than or in addition to the ink attribute 506. The condition may also appear in the display list root in addition to or in the absence of a condition appearing in one or more of the display list objects.

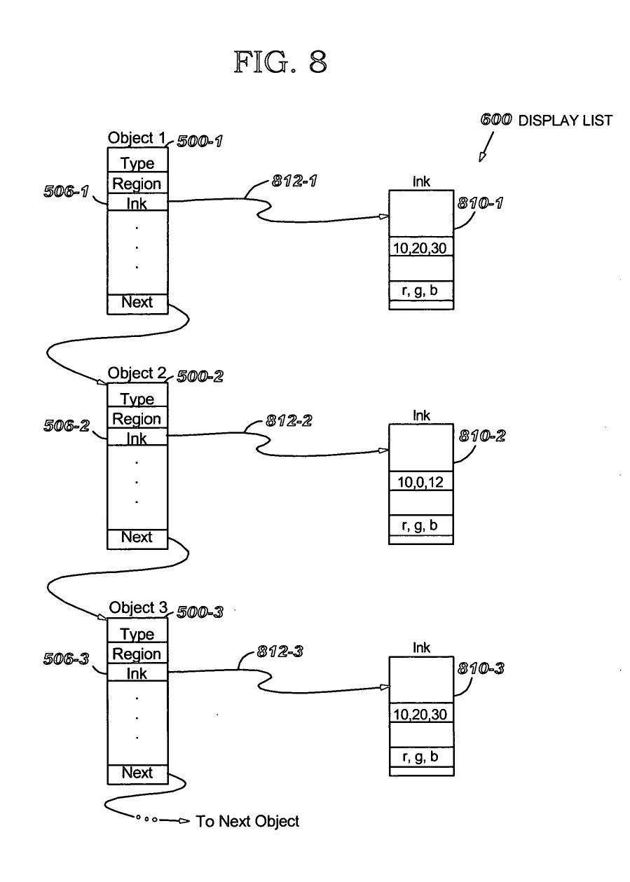

With reference to FIG. 8, a display list 600 representative of a working example of the present invention includes objects 500-1, 500-2, and 500-3 for the first three to-be-printed objects of a to-be-printed page. In turn, each of their ink attributes 506-1, 506-2, 506-3 points to memory locations or addresses 810-1, 810-2, 810-3 via the functionality of a pointer 812-1, 812-2, 812-3, respectively. Preferably, but not required, each memory location resides within the dedicated memory M of the graphics engine. As skilled artisans will observe, the r, g, b values corresponding to the to-be-printed objects 1 and 3 have the same values, e.g., 10, 20, 30, while the r, g, b values corresponding to the to-be-printed object 2 are different, e.g., 10, 0, 12. To save memory space and achieve other advantage in accordance with the invention, the graphics engine can release or free the memory locations of the redundant values, e.g., those found in 810-3.

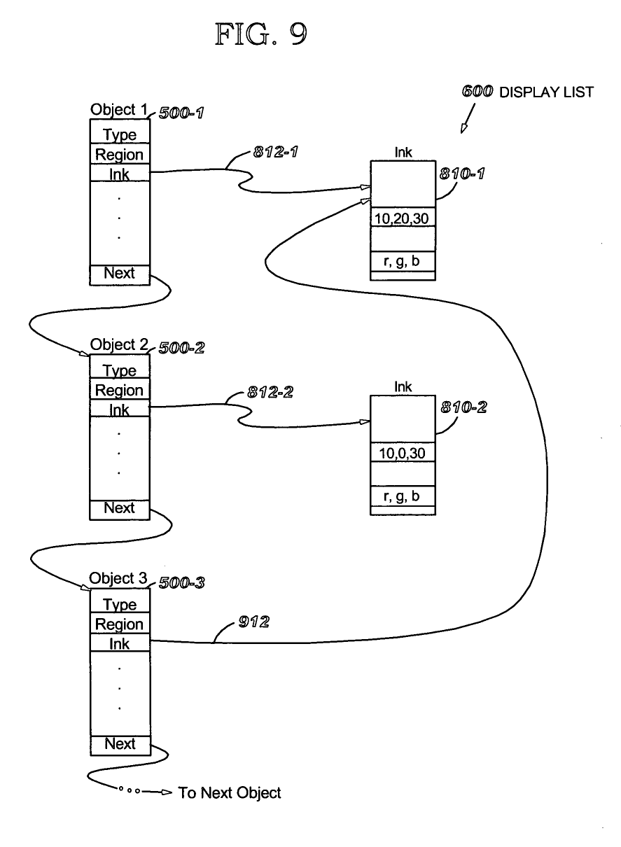

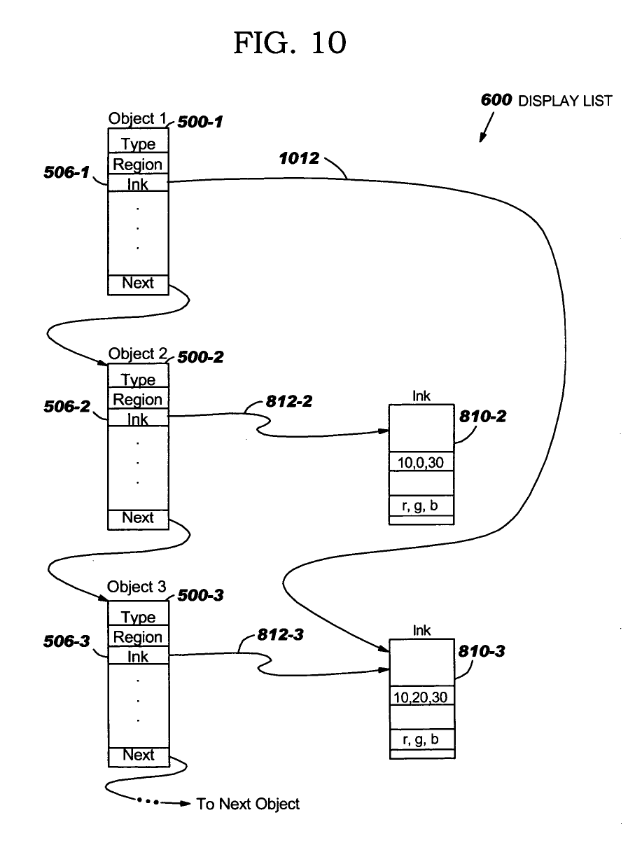

With reference to FIG. 9, the graphics engine releases the memory locations 810-3 of the third to-be-printed object 500-3 and constructs a modified pointer 912 that points to the memory locations 810-1 having the same information. In this manner, the graphics engine or other structure has more available memory to use in other processing operations as required. In other embodiments, FIG. 10, the memory locations of 810-1 could have been freed in favor of the memory locations 810-3 such that a modified pointer 1012, corresponding to the ink attribute 506-1 of the display list object 500-1, becomes created to point to the memory locations 810-3 having the same information.

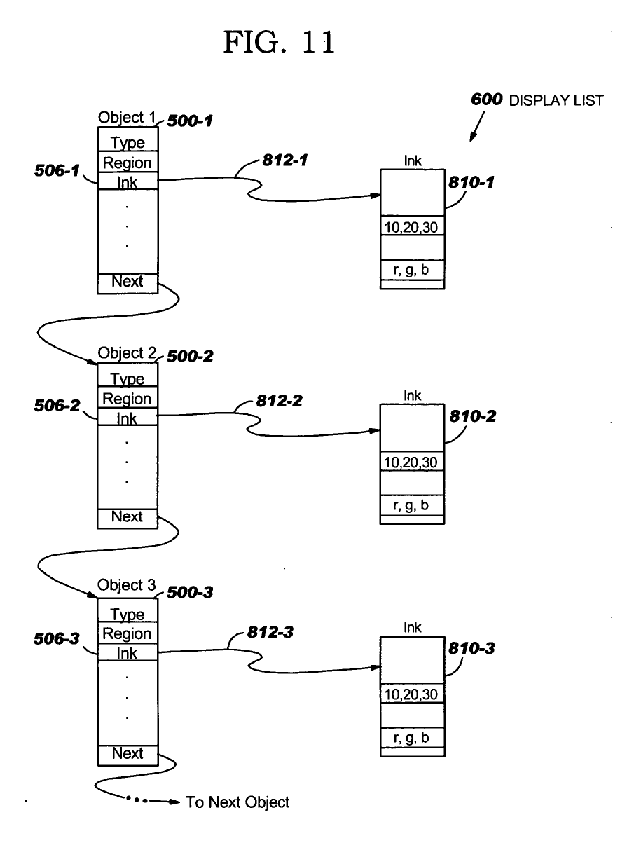

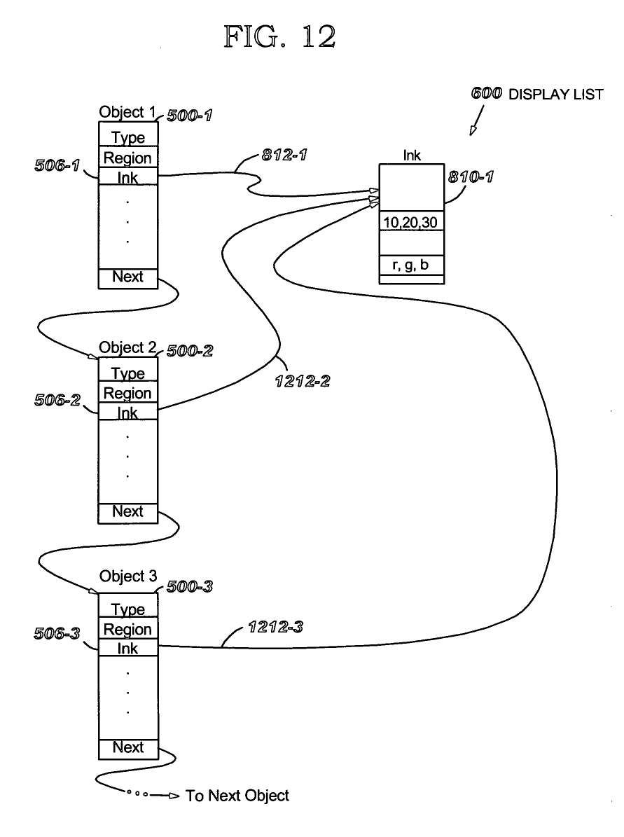

In each of FIGS. 8-10, skilled artisans will further observe that the redundant memory locations exist for to-be-printed objects not sequentially ordered on the display list 600 for the to-be-printed page. Appreciating that the present invention is not so limited, FIG. 11 represents a display list 600 having sequentially presented to-be-printed objects, and plural to-be-printed objects, e.g., objects 1, objects 2, objects 3, having the same r, g, b values (e.g., 10, 20, 30) therefor. Thus, with reference to FIG. 12, the original pointers corresponding to the ink attributes 506-2, 506-3 of the display list objects 500-2, 500-3 for the second and third to-be-printed objects become modified into pointers 1212-2, 1212-3 to point at the memory locations 810-1 that contain the same color value information as their original memories. The graphics engine also frees the redundant memory locations 810-2 and 810-3 so that it or other structures will have access to these memory locations for other processing operations as necessary.

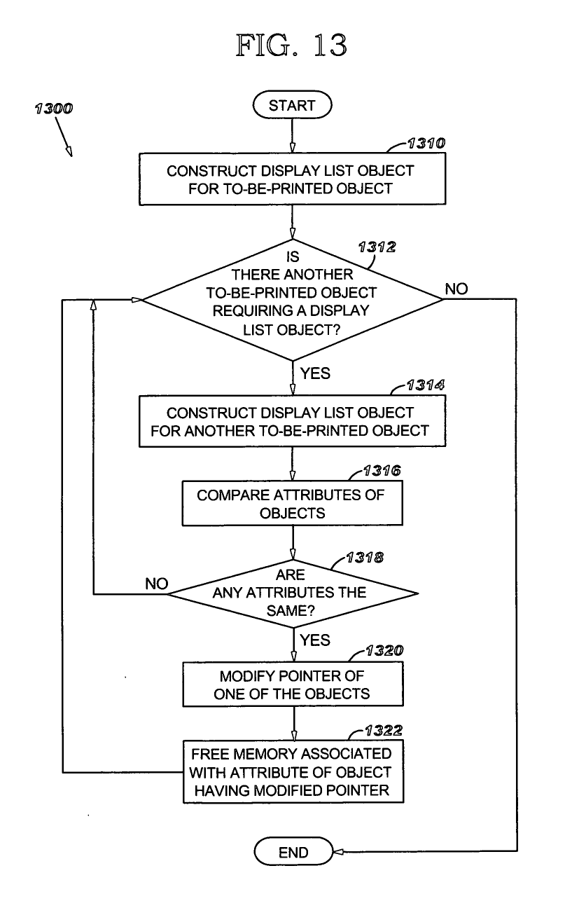

Still further, the advantage realized by freeing redundant memory locations for use with other processing operations can also be accomplished for other attributes of the objects on the display list and includes the object type attributes and object region attributes or other known or hereinafter invented attributes. Thus, with reference to FIG. 13, an overall flow chart for one aspect of optimizing print jobs in a rendering device appears generally as 1300. At step 1310, the graphics engine constructs a display list having an object corresponding to a to-be-printed object of a to-be-printed page of a print job. At step 1312, if additional display list objects require creation for additional to-be-printed objects, the graphics engine constructs them at step 1314. If not, there is no reason to compare attributes and the process can end along the No route of step 1312. Conversely, at step 1316, if more than one display list object has been created, the graphics engine compares their attributes to determine whether any are the same, step 1318. If the attributes are the same, the pointer of one of the objects on the display list becomes modified to point to the memory locations of the other object having the same information stored therein. At step 1322, the memory location(s) associated with the attribute of the object with the modified pointer now becomes freed or released and can be used for future processing as necessary. Appreciating that the to-be-printed page may have additional to-be-printed objects, the process repeats at steps 1318 and 1322. Eventually, no more display list objects will exist and the process ends along the No route from step 1312. The foregoing process presumes, however, that the graphics engine searches for object attribute redundancies at the same time the graphics engine creates the display list objects. In alternate embodiments, the same process occurs with the exception that the graphics engine constructs the entire display list for a to-be-printed page and, once completed, then traverses the display list searching for attributes of individual objects having redundancies. Still further, the graphics engine may alternatively perform step 1322 before step 1320 without losing any advantage of the present invention.

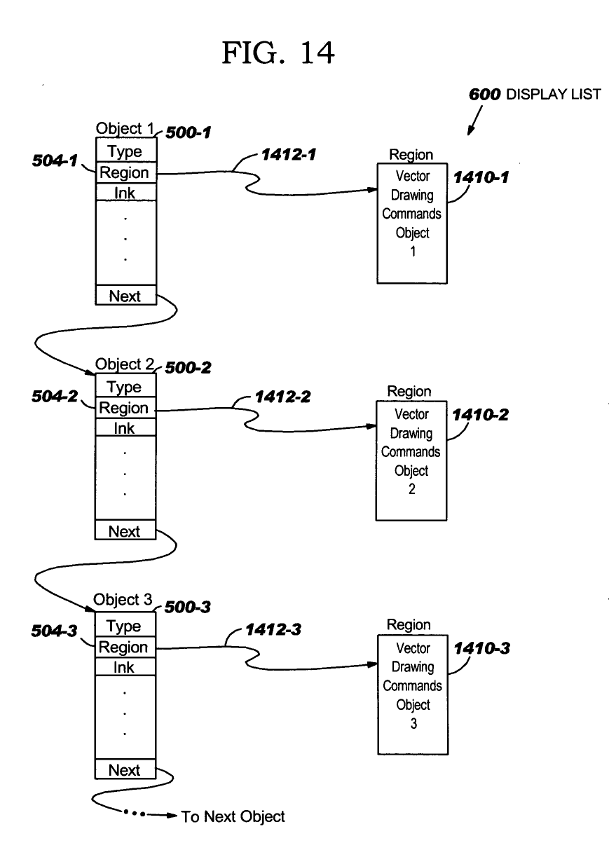

With reference to FIG. 14, display list objects 500-1, 500-2, 500-3, have region attributes 504-1, 504-2, 504-3, with pointers 1412-1, 1412-2, 1412-3 to memory locations 1410-1, 1410-2, 1410-3. In turn, the memory locations contain vector drawing commands, among other things, relative to drawing their corresponding to-be-printed object. Sometimes, the vector drawing commands for one object have comparability or compatibility to the vector drawing commands of another object. For instance, they may have a same starting origin, a same rasterization method or a same ink color. As such, memory optimization can be achieved by combining or appending the vector drawing commands of one object onto those of another object and then freeing unneeded memory locations. Preferably, the appending only occurs when the ink attributes of the objects have the same color values.

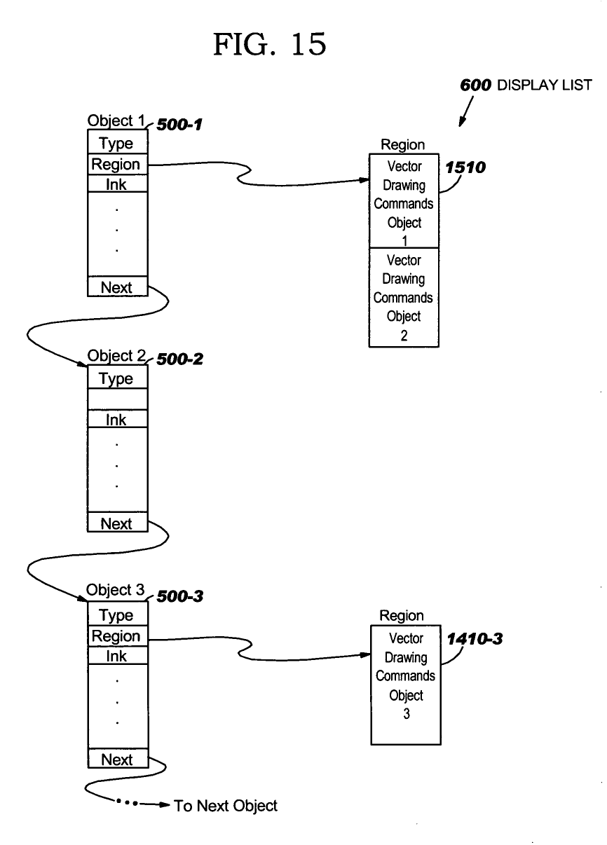

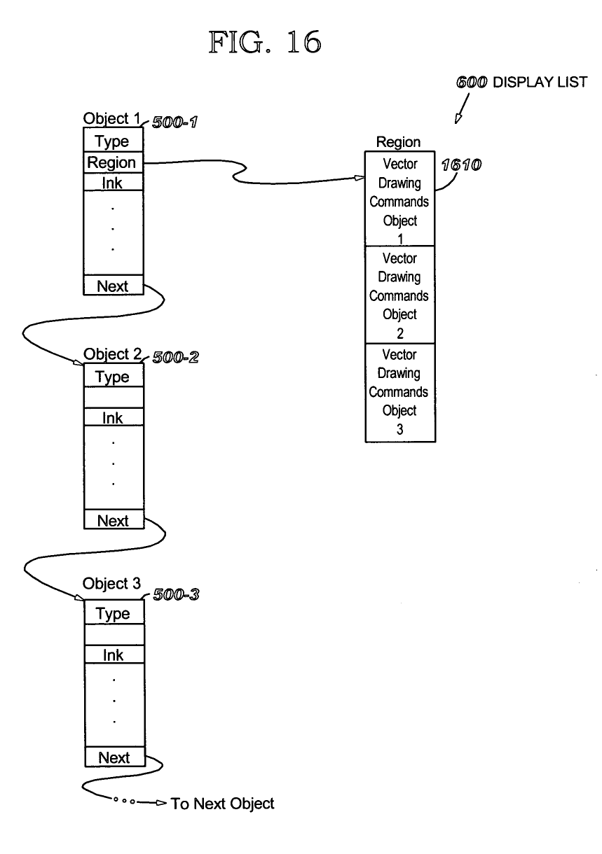

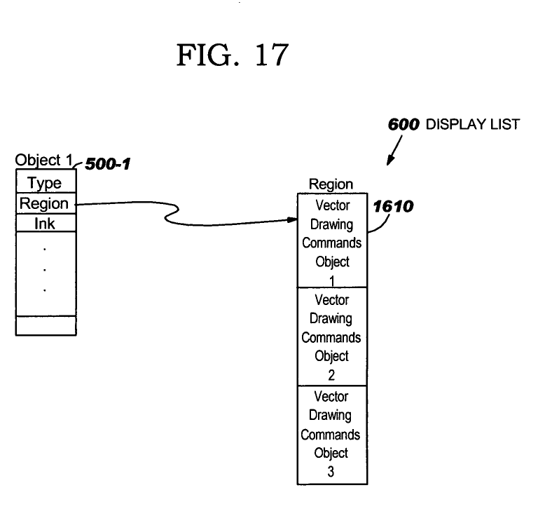

By comparing FIGS. 14 and 15, such occurs by combining the region attributes, especially the vector drawing commands, of display list object 500-2 with those of display list object 500-1 in memory locations 1510. Then, the memory locations 1410-2 can be freed because the display list object 500-2 no longer requires a pointer 1412-2 or a region attribute. It is preferred, but not required, that the combining of vector drawing commands in the region attributes of a to-be-printed object will occur for adjacent to-be-printed objects on a given display list 600 for a given to-be-printed page. In another embodiment, FIG. 16, the combining or appending of vector drawing commands of region attributes can occur for more than one to-be-printed object by placing all the vector drawing commands into memory locations 1610, freeing the memory locations 1410-2, 1410-3 (FIG. 14) and eliminating region attributes and their associated pointers 1412-2, 1412-3. In some instances, FIG. 17, it may even be possible to altogether eliminate unneeded objects, e.g., object 2, object 3, from the display list 600 once their attributes are combined.

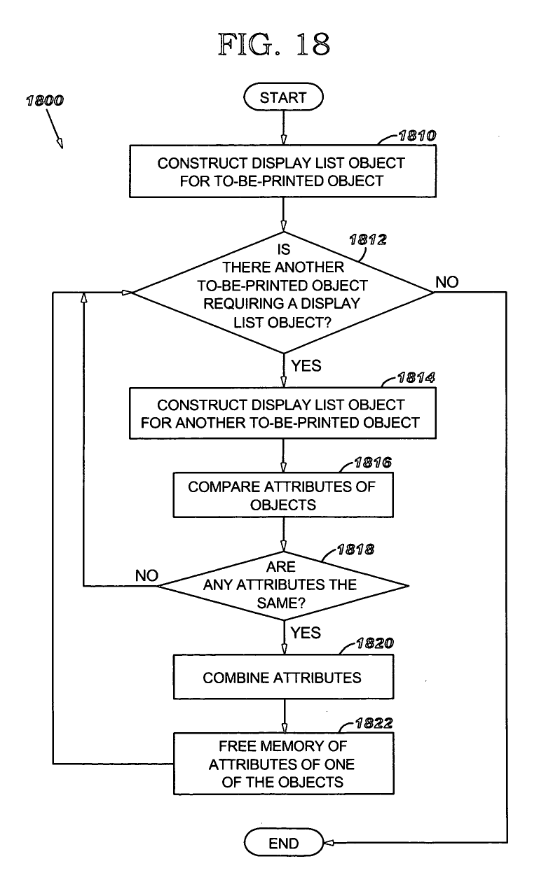

The advantage realized by combining memory locations can also be accomplished for other attributes of objects on the display list and includes the object type attributes and object ink attributes or other known or hereinafter invented attributes. Thus, with reference to FIG. 18, an overall flow chart for another aspect of optimizing print jobs in a rendering device appears generally as 1800. At step 1810, the graphics engine constructs a display list having an object corresponding to a to-be-printed object of a to-be-printed page of a print job. At step 1812, if additional display list objects require creation for additional to-be-printed objects, the graphics engine constructs them at step 1814. If not, there is no reason to compare attributes and the process can end along the No route of step 1812. Conversely, at step 1816, if more than one display list object has been created, the graphics engine compares their attributes to determine whether any are compatible or otherwise comparable, step 1818. If the attributes are comparable, they become combined at step 1820 and the memory of the attributes of one of the objects becomes freed along with elimination of its pointer, step 1822. Alternatively, it may even be possible to altogether eliminate the object from the display list at this point. After this step, the freed memory locations can be used for future processing as necessary. Appreciating that the to-be-printed page may have additional to-be-printed objects, the process repeats at steps 1818 and 1822. Eventually, no more display list objects will exist and the process ends along the No route from step 1812. The foregoing process presumes, however, that the graphics engine searches for object attribute comparability at the same time the graphics engine creates the display list objects. In alternate embodiments, the same process occurs with the exception that the graphics engine constructs the entire display list for a to-be-printed page and, once completed, then traverses the display list searching for attributes of individual objects having comparability.

Hereafter, the graphics engine renders the to-be-printed objects into device specific pages in memory. In one embodiment, this includes the graphics engine ascertaining the object type attribute 502-1 of the to-be-printed object; ascertaining the object region attribute 504-1; and converting the color information, on a pixel-by-pixel basis for that to-be-printed object, into the device specific colors (e.g., CMYK) as previously described. Next, it performs well-known halftone operations for the to-be-printed object so it will appear properly to the human eye when viewed as a hard copy output. Next, the memory addresses or locations corresponding to that object, i.e., the display list object 500-x, are released or freed so that the graphics engine or other structure can use them for future operations as necessary. If additional to-be-printed objects appear on the display list that require rendering, the graphics engine repeats the process until all to-be-printed objects are rendered in memory. At this point, the graphics engine can hand-off the bitmap, in device specific colors and halftoned, directly to the engine interface 216 (FIG. 2) to invoke the print mechanisms 218 of the printer 161 for producing a hard copy sheet. Of course, if additional to-be-printed pages, e.g., 2, 3 . . . N existed in a given print job, the graphics engine could wait until all to-be-printed pages became rendered before executing the hand-off.

In general, it is known to have either host based control of printing or to have device or printer based control of printing. Heretofore, printer based control has been exclusively described. In an alternate embodiment, however, the foregoing could be implemented through host-based control wherein the printer driver, installed on the host from some sort of software media, e.g., optical disk 131 (FIG. 1), alone or in combination with the computer 120, could perform the above-described processing through the implementation of computer-executable instructions on the driver or elsewhere. In still another embodiment, although the foregoing has been described in relationship to a laser printer, e.g., 161, no reason exists why this could not extend to inkjet printers, fax machines, copy machines, monitors, or other output-type rendering devices that provide output renditions for a given input.

The present invention has been particularly shown and described with respect to certain preferred embodiment(s). However, it will be readily apparent to those skilled in the art that a wide variety of alternate embodiments, adaptations or variations of the preferred embodiment(s), and/or equivalent embodiments may be made without departing from the intended scope of the present invention as set forth in the appended claims. Accordingly, the present invention is not limited except as by the appended claims.

1. A method for processing a print job in a rendering device, comprising:
constructing at least two display list objects for to-be-printed objects of said print job, each said display list object having attributes thereof; and
comparing said attributes of said at least two display list objects.

2. The method of claim 1, further including freeing memory locations of said attributes associated with one of said at least two display list objects.

3. The method of claim 1, further including modifying a pointer associated with one of said at least two display list objects.

4. The method of claim 1, further including eliminating a pointer associated with one of said at least two display list objects.

5. The method of claim 1, further including appending vector drawing commands of one of said at least two display list objects onto vector drawing commands of the other of said at least two display list objects.

6. The method of claim 1, further including constructing an ink attribute, a region attribute and a type attribute for each of said at least two display list objects.

7. The method of claim 1, further including eliminating an entirety of one of said at least two display list objects.

8. The method of claim 1, further including more than said at least two display list objects wherein said comparing said attributes further includes comparing said attributes of adjacent display list objects.

9. The method of claim 1, further including rendering said to-be-printed objects into a device specific page in memory.

10. A computer readable media having computer executable instructions for performing the steps recited in claim 1.

11. A printer having a graphics engine with computer executable instructions stored in a memory accessible by the graphics engine for performing the steps recited in claim 1.

12. A method for processing a print job in a rendering device, comprising:
constructing a plurality of display list objects for to-be-printed objects of said print job, each said display list object having an ink attribute and a region attribute; and
one of comparing said ink attributes of two or more said display list objects for sameness and comparing said region attributes of two or more said display list objects for compatibility.

13. The method of claim 12, further including receiving an indication that all said to-be-printed objects have been presented.

14. The method of claim 12, wherein said comparing said region attributes further includes examining vector drawing commands of adjacent said display list objects.

15. The method of claim 14, further including appending said vector drawing commands of one of said display list objects onto said vector drawing commands of another of said display list objects.

16. The method of claim 15, further including eliminating a pointer associated with said one of said display list objects.

17. The method of claim 15, further including freeing memory locations of said vector drawing commands of said one of said display list objects.

18. The method of claim 12, wherein said comparing said ink attributes further includes examining color values of said display list objects for substantial similarity.

19. The method of claim 18, further including modifying a pointer associated with one of said display list objects to point at said color values of another of said display list objects.

20. The method of claim 19, further including freeing memory locations of said color values of said one of said display list objects.

21. A method for processing a PDL print job in a printer, said PDL print job having at least two to-be-printed objects, comprising:
receiving an indication that said at least two to-be-printed objects have been presented;
constructing a display list object for each of said at least two to-be-printed objects, each said display list object having an ink attribute and a region attribute;
comparing said ink attributes of each said display list object;
comparing said region attributes of said each said display list object; and
rendering said at least two to-be-printed objects into a device specific page in memory.

22. The method of claim 21, wherein said comparing said ink attributes further includes examining color values thereof for sameness.

23. The method of claim 21, wherein said comparing said region attributes further includes examining vector drawing commands thereof for compatibility.

24. The method of claim 21, further including freeing some memory locations of said ink attributes and said region attributes.

25. The method of claim 21, further including modifying or eliminating a pointer associated with one of said display list objects.

26. A method for processing a PDL print job in a printer, said PDL print job having a plurality of to-be-printed objects on a to-be-printed page, comprising:
receiving an indication that said to-be-printed objects have been presented;
constructing a display list for said to-be-printed page, said display list having an object for each of said to-be-printed objects and a root, each said object having an ink attribute and a region attribute;
comparing color values of said ink attributes of each said object for sameness;
comparing vector drawing commands of said region attributes of said each said object for compatibility;
one of modifying and eliminating a pointer associated with one of said objects;
freeing memory locations of said color values and said vector drawing commands; and
rendering said to-be-printed objects into a device specific page in memory.

27. A method for processing a print job in a rendering device, comprising:
comparing attributes of display list objects for to-be-printed objects of said print job; and
sharing said attributes.

28. The method of claim 27, wherein said sharing further includes freeing memory locations of said attributes.

29. The method of claim 27, further including modifying a pointer of one of said display list objects.

30. The method of claim 27, wherein said sharing further includes appending vector drawing commands of one of said display list objects onto vector drawing commands of another of said display list objects.

31. The method of claim 27, wherein said comparing further includes examining said attributes between adjacent said display list objects.

32. The method of claim 27, wherein said comparing further includes one of comparing color values of ink attributes of each said display list object for sameness and comparing vector drawing commands of region attributes of said each said display list object for compatibility.

33. The method of claim 27, further including rendering said to-be-printed objects into a device specific page in memory.

34. A computer readable media having computer executable instructions for performing the steps recited in claim 27.

35. A printer having a graphics engine with computer executable instructions stored in a memory accessible by the graphics engine for performing the steps recited in claim 27.

36. A method for processing a PDL print job in a printer, said PDL print job having a plurality of to-be-printed objects on a to-be-printed page, comprising:
receiving an indication that said to-be-printed objects have been presented;
constructing a display list for said to-be-printed page, said display list having an object display list for each of said to-be-printed objects and a root, each said object having an ink attribute and a region attribute;
comparing color values of said ink attributes of each said object for sameness;
comparing vector drawing commands of said region attributes of said each said object for compatibility;
sharing one said ink attributes and said region attributes; and
rendering said to-be-printed objects into a device specific page in memory.
